(19) United States
(12) Patent Application Publication
(10) Pub. No.: US 2010/0072894 A1
(43) Pub. Date: Mar. 25, 2010

(54) LAMP DEVICE AND LIGHTING APPARATUS

(75) Inventors: Yusuke SHIBAHARA, Yokosuka-shi (JP); Makoto BESSHO, Yokohama-shi (JP); Hiroki TAMAI, Yokosuka-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOSHIBA LIGHTING & TECHNOLOGY CORPORATION, Yokosuka-shi (JP)

(21) Appl. No.: 12/562,577

(22) Filed: Sep. 18, 2009

(30) Foreign Application Priority Data
Sep. 19, 2008 (JP) 2008-241175
Sep. 30, 2008 (JP) 2008-253509
Nov. 26, 2008 (JP) 2008-300913

(51) Int. Cl. H01J 7/44

(52) U.S. Cl. 315/32

(57) ABSTRACT

A lamp device includes: a substrate; a light emitting element mounted on the substrate; a heat transfer body having a peripheral wall portion having one end expanding toward another one end, the substrate being attached to an inner surface of the one end of the heat transfer body; a plurality of heat radiation fins disposed at the another one end of the peripheral wall portion of the heat transfer body; a cover attached to the one end of the heat transfer body; a base mounted to one end of the cover; and a lighting circuit disposed inside the cover and adapted to trigger light emission of the light emitting element. A lighting apparatus is composed of a lighting apparatus housing, a socket disposed in the lighting apparatus housing, and a lamp device of the structure mentioned above.

### BACKGROUND OF THE INVENTION

1. Field of the Invention

The present invention relates to a lamp device incorporating a light emitting element and also relates to a lighting apparatus incorporating the lamp device.

2. Description of the Related Art

A conventional lamp device incorporating a light emitting diode (LED), used as an alternative to a light bulb, includes an LED mounted on a substrate, a metal radiator with the substrate attached thereto, a base attached to the radiator with a cover interposed therebetween, and a lighting circuit for the LED housed in the cover.

The lamp device further includes a plurality of heat radiation fins around the radiator in order to reduce the increase of temperature of the LED caused by the heat generated by the LED itself, which may cause reduction of the optical output of the LED and shortening of the life of the LED (see Patent Publication 1: Japanese Patent Laid-Open No. 2007-48638, for example).

However, if this type of lamp device is attached to a lighting apparatus including conventional light bulb, a problem arises that the heat radiation rate or performance of the heat radiation fins decreases because the heat radiation fins are disposed inside the lighting apparatus.

Furthermore, some of the lamp devices are also provided with a reflector or reflecting member having a cylindrical shape. In such lamp device, heat of the LED likely transfers and stays inside through the reflector. Accordingly, it becomes difficult to effectively the heat of the LED to the radiation fins on a low temperature side, thus providing disadvantageous effect.

Furthermore, in a further conventional lamp device, a heat radiation member is specifically disposed and a substrate is disposed so as to contact a peripheral edge portion of the heat radiation member only providing a linearly contacting structure. In such conventional structure, sufficient heat radiation effect is not achieved.

### SUMMARY OF THE INVENTION

The present invention was conceived in consideration of the circumstances mentioned above, and an object of the present invention is to provide a lamp device capable of improving heat radiation effects and also provide a lighting apparatus incorporating the lamp device.

This and other objects can be achieved according to the present invention by providing, in one aspect, a lamp device, comprising:

a substrate;

a light emitting element mounted on the substrate;

a heat transfer body having a peripheral wall portion having one end expanding toward another one end, the substrate being attached to an inner surface of the one end of the heat transfer body;

a plurality of heat radiation fins disposed at the another one end of the peripheral wall portion of the heat transfer body;

a cover attached to the one end of the heat transfer body;

a base mounted to one end of the cover; and

a lighting circuit disposed inside the cover and adapted to trigger light emission of the light emitting element.

In this aspect, there may be provided the following preferred embodiments.

The lamp device may further comprises a cylindrical member disposed inside the heat transfer body, the cylindrical member having opened one end expanding toward another opened one end, wherein the opened one end is separated, in non-contact state, from the substrate and the heat transfer body and the another opened one end of the cylindrical member is fixed to the another one end of the heat transfer body.

The cylindrical member may be composed as a reflector having an inner surface formed as a reflecting surface for reflecting light from the light emitting element.

The cover may include an outer cover and an inner cover, the inner cover including an insulating case having a housing in which the lighting circuit is housed, wherein the base is mounted to be communicated with the housing of the insulating case so as to close one end side of the insulating case, and a heat conductive resin fills the housing to the closed one end side of the insulating case with the lighting circuit being housed therein. The heat conductive resin may be a silicone resin.

It may be desired that the insulating case may has a peripheral wall portion to which a through hole is formed so as to face an inner surface of the cover. The through hole includes a plurality of slits arranged at a predetermined interval and each having a rectangular shape.

It may be further desired that an apparatus attachment portion to be tightly attached to a lighting apparatus housing is formed on an outer surface of the peripheral wall portion of the heat transfer body, and the heat radiation fins protrude toward the another end of the lamp device beyond the apparatus attachment part.

In another aspect of the present invention, there is also provided a lighting apparatus comprising:

a lighting apparatus housing;

a socket disposed in the lighting apparatus housing; and

a lamp device comprising: a substrate; a light emitting element mounted on the substrate; a heat transfer body having a peripheral wall portion having one end expanding toward another one end, the substrate being attached to an inner surface of the one end of the heat transfer body; a plurality of heat radiation fins disposed at the another one end of the peripheral wall portion of the heat transfer body; a cover attached to the one end of the heat transfer body; a base mounted to one end of the cover; and a lighting circuit disposed inside the cover and adapted to trigger light emission of the light emitting element,

wherein the base of the lamp device is fitted into the socket, and the peripheral wall portion of the heat transfer body of the lamp device is tightly attached to the lighting apparatus housing at an outer surface thereof.

In the present invention of the aspects mentioned above, the following preferable modes may be further taken.

The light emitting element may be a solid light emitting element, such as an LED and an organic EL.

The substrate may be made of a metal material having a high heat radiation rate, such as aluminum, and may be an LED module comprising a plurality of LEDs.

The heat transfer body may be made of a metal material having a high heat radiation rate, such as aluminum, or a ceramic or other material. That is, the heat transfer body can be made of any heat conductive material. The outer surface of the peripheral wall portion may be a smooth continuous curved surface that has no heat radiation fins or other projections arranged in the circumferential direction. Alternatively, the peripheral wall portion expanding from one end to the other end of the heat transfer body may have a heat radiating structure having projections and depressions, for example.

The plurality of heat radiation fins are radially arranged at the other end of the peripheral wall part of the heat transfer body, and light from the light emitting elements passes through the space inside the heat radiation fins. Gaps between the heat radiation fins open to the other end of the lamp device and to the side of the lamp device. The plurality of heat radiation fins may be formed separately from and assembled onto the heat transfer body or may be formed integrally with the heat transfer body.

The cover may be an insulating synthetic resin, for example.

The base may be one that can be connected to a socket for a light bulb, such as the E26 base.

The lighting circuit supplies a constant direct-current power to the LEDs, for example.

A reflecting mirror as reflector for reflecting light from the light emitting element may be provided in the heat transfer body.

The apparatus attachment portion may be tightly attached to the lighting apparatus housing with a packing interposed therebetween, for example.

According to the present invention of the structures and embodiments mentioned above, the following advantageous functions and effects may be provided.

In the lamp device, the substrate is attached to the inner surface of one end the heat transfer body, and the plurality of heat radiation fins are disposed on the other end of the peripheral wall part of the heat transfer body expanding toward the other end of the lamp device. Therefore, even when the lamp device is attached to a conventional lighting apparatus, the heat radiation fins are always disposed on the outside of the lighting apparatus, so that the heat radiation fins can efficiently radiate heat. In addition, since the outer surface of the peripheral wall portion of the heat transfer body is tightly attached to the lighting apparatus, the lamp device can be applied to a water-proof structure.

Furthermore, since the heat radiation fins protrude beyond the apparatus attachment portion of the heat transfer body tightly attached to the lighting apparatus, the heat radiation fins are always disposed outside of the lighting apparatus even after the lamp device is attached to the lighting apparatus, so that the heat radiation fins can efficiently radiate heat.

Furthermore, the non-contact arrangement of the cylindrical member (reflector) to the substrate and the heart transfer body further improves the temperature reduction efficiency, thus preventing the reduction of the light emission and reduction of use life can be prevented.

In the structure having the insulating case as inner cover, the heat conductive resin is housed therein, the heat radiation through the heat conductive resin to the outer cover can be enhanced.

The nature and further characteristic features and advantageous functions of the present invention will be made clearer from the following descriptions made with reference to the accompanying drawings.

### BRIEF DESCRIPTION OF THE DRAWINGS

In the accompanying drawings:

FIG. 1 is a view showing a lighting apparatus incorporating a lamp device, partially in section, according to a first embodiment of the present invention;

FIG. 2 is a view showing a lighting apparatus incorporating a lamp device, partially in section, according to a second embodiment of the present invention;

FIG. 3 is a view showing a lamp device, partially in section, for a lighting apparatus according to a third embodiment of the present invention;

FIG. 4 shows an essential portion of the lamp device of FIG. 3, in which a part of insulation cover is cut away; and

FIG. 5 illustrates a lighting apparatus provided with a lamp device according to the present invention, in which a lamp device shown in FIG. 2 is mounted as one example.

### DESCRIPTION OF THE PREFERRED EMBODIMENTS

In the following, embodiments of the present invention will be described with reference to the accompanying drawings. It is further to be noted that terms “upper”, “lower”, “right”, “left” and like terms are used herein with reference to illustrations of the drawings.

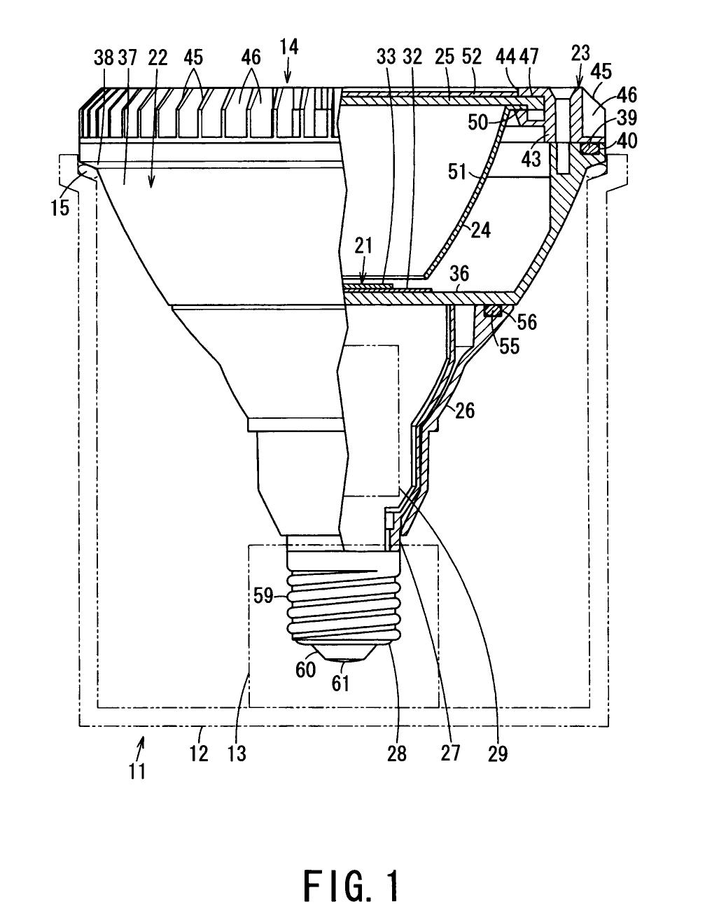

With reference to FIG. 1, reference numeral 11 denotes a lighting apparatus, which is designed for outdoor use and has a water-proof structure. The lighting apparatus 11 has a lighting apparatus housing 12 as a apparatus body, a socket 13 disposed in the housing 12 and a lamp device 14 mounted to the socket 13 to be tightly mounted to the lighting apparatus housing 12.

The lighting apparatus housing 12 has a cylindrical shape opened at one end. The lamp device 14 is in intimate contact with the inner surface of the open end of the lighting apparatus housing 12 in a liquid tight manner with an annular packing 15 interposed therebetween and is fastened to the housing 12 by means of screw or the like, not shown.

The lamp device 14 has an LED module 21. The LED module 21 is attached to the inner surface of one end of a heat transfer body 22 along the axis of the lamp device. An annular heat radiation fin unit 23 including a plurality of heat radiation fins 45 is attached to the perimeter of the other end of the heat transfer body 22. A reflector 24 and a light transmitting plate 25 serving as a light controller are attached to the heat radiation fin unit 23. An outer cover 26 and an inner cover 27 are attached to the one end of the heat transfer body 22. A base 28 is attached to one end of the inner cover 27. A lighting circuit unit 29 is housed in the outer cover 26.

The LED module 21 has a substrate 32 having a circular shape, for example, and a plurality of LEDs 33 as light emitting elements mounted on one surface of the substrate 32.

The substrate 32 is made of a metal material having a high heat radiation rate, such as aluminum. The other surface of the substrate 32 is in surface contact with and tightly fixed to the heat transfer body 22. The substrate 32 is fixed to the heat transfer body 22 with a silicone adhesive having high heat conductivity or by means of screw, for example.

Each of the LEDs 33 has a bare chip, not shown, that emits blue light, for example, and a resin portion, not shown, made of silicone or other resin material covering the bare chip. The resin material forming the resin portion is mixed with a fluorescent material excited by a part of the blue light emitted by the bare chip to primarily radiate light of yellow color, which is a complementary color of blue. This allows each LED 33 to emit substantially white light.

The heat transfer body 22 is made of a metal material having a high heat radiation rate, such as aluminum. The heat transfer body 22 has a substrate mount portion 36 having a flat disc shape at one end and a peripheral wall portion (expansion portion) 37 expanding from the perimeter of the substrate mount part 36 toward the other end of the heat transfer body 22 so as to be expanded toward the other end opening. The outer surface of the peripheral wall portion 37 is a smooth curved surface that is continuous in the circumferential direction.

An apparatus attachment portion 38 protrudes from the outer surface of the peripheral wall portion 37 along the edge closer to the other end of the lamp device. The apparatus attachment portion 38 is to be tightly attached to the lighting apparatus housing 12 with the packing 15 interposed therebetween.

The peripheral wall portion 37 has an annular groove 40 formed in the end face closer to the other end of the lamp device. An annular packing 39 is fitted into the annular groove 40 to ensure intimate liquid tight contact with the heat radiation fin unit 23.

The heat radiation fin unit 23 is made of a metal material having a high heat radiation rate or performance, such as aluminum. The heat radiation fin unit 23 has an annular base portion 43 to be connected to the end surface of the heat transfer body 22. An opening 44 for light from the LEDs 33 to pass through is formed inside the annular base portion 43, and a plurality of heat radiation fins 45 are radially arranged around the annular base portion 43.

The heat radiation fins 45 are radially formed along the circumferential direction of the base portion 43 at substantially equal intervals. Gaps 46 are formed between the heat radiation fins 45. The gaps 46 between the heat radiation fins 45 are opened to the other side (i.e., front side) end of the lamp device 14 and to the periphery of the lamp device 14.

The corner of the heat radiation fin 45 closer to the other end of the lamp device is chamfered.

The base portion 43 has a light controller attachment 47 to which the reflector 24 and the light transmitting plate 25 are attached in a liquid-tight manner.

The reflector 24 is made of a metal or resin material, for example, and has a cylindrical shape that opens in the axial direction of the lamp device and expands in the direction from one end to the other end. The reflector 24 has a flanged portion 50 to be connected to the light controller attachment 47 of the heat radiation fin unit 23 at the other end. The inner surface of the reflector 24 constitutes a reflecting surface 51 that reflects light from the LEDs 33 to the light transmitting plate 25.

As mentioned above, it is preferred for the reflector 24 to have cylindrical structure in which one end side 24a thereof does not contact the substrate 32 and the substrate mount portion 36 of the heat transfer body 22. According to such structure, the heat generated from the LED 33 is hardly transferred to the cylindrical reflector 24, thus suppressing the increase of the temperature of the one end 24a of the reflector 24.

Further, the inner surface 22a of the heat transfer body 22 is coated with a heat absorbing material, and the outer surface 22b of the heat transfer body 22 is coated with a heat radiating material.

The light transmitting plate 25 is made of glass or a resin material, for example, and has a shape of disc. The light transmitting plate 25 is attached to the light controller attachment 47 of the heat radiation fin unit 23 at the perimeter in a liquid-tight manner with a packing, not shown, interposed therebetween. A light transparent film 52 is applied to the front surface of the light transmitting plate 25.

The outer cover 26 is made of a metal or a resin material and has a conical shape smoothly connected to the heat transfer body 22. The outer cover 26 has an annular groove 56 formed in the end surface closer to the other end of the lamp device. An annular packing 55 is fitted into the annular groove 56 to ensure intimate liquid tight contact with the heat transfer body 22. The outer cover 26 is fixed to the heat transfer body 22 with a screw inserted from the side of the heat transfer body 22.

The inner cover 27 is made of an insulating resin material, such as PBT resin, and has a cylindrical shape conforming to the inner surface of the outer cover 26. The inner cover 27 protrudes beyond the outer cover 26 at one end, and the base 28 is attached to the protruding end of the inner cover 27.

The base 28 is the E26 base, for example, having a threaded tubular shell 59 to be screwed into the socket 13 of the lighting apparatus 11 and an eyelet 61 formed on the top of one end of the shell 59 with an insulating portion 60 interposed therebetween. The shell 59 and the eyelet 61 are electrically connected to the lighting circuit unit 29 by a lead, not shown.

The lighting circuit 29 is electrically connected to the substrate 32 of the LED module 21 by means of lead so as to supply a constant current to the LEDs 33.

The lamp device 14 configured as described above is connected to the socket 13 in the lighting apparatus housing 12 at the base 28 and then tightly attached to the lighting apparatus housing 12 in a liquid tight manner at the apparatus attachment portion 38 of the heat transfer body 22 with the packing 15 interposed therebetween.

When the lamp device 14 is attached to the lighting apparatus housing 12, the heat radiation fins 45 protrude beyond the end face of the lighting apparatus housing 12 and thus are exposed to the outside.

When electric current is conducted to the lamp device 14 through the socket 13, the lighting circuit unit 29 starts to supply power to the substrate 32 of the LED module 21 to cause the LEDs 33 to emit light.

The light from the LEDs 33, a part of which directly reaches the light transmitting plate 25 and a remaining part is reflected on the reflector 24 to reach the light transmitting plate 25, is transmitted through the light transmitting plate 25 and radiated to the outside.

Heat generated by the light emission of the LEDs 33 is primarily transferred from the substrate 32 to the heat transfer body 22 and then to the heat radiation fin unit 23 and secondarily transferred from the reflector 24 to the heat radiation fin unit 23. Then, the heat is radiated from the plurality of heat radiation fins 45 of the heat radiation fin unit 23 into the outside air of the lighting apparatus 11.

Furthermore, the cylindrical reflector 24 blocks the heat from the LEDs 33 and prevents the heat from being radiated directly to the inner surface of the heat transfer body 22. This facilitates heat transfer from the high temperature portion of the LED module 21 to the low temperature portion on the outer surface side of the heat transfer body 22.

Furthermore, in a preferred embodiment of the present invention, since the heat transfer body 22 is made of a metal having a heat conductivity of 150 W/mK or higher, such as aluminum (Al), the heat transfer body 22 quickly transfers the heat from the substrate mount portion 36 of the LED module 21 to the heat radiator fin unit 23 and radiates the heat from the heat radiator fin unit into the outside space. Thus, the heat is less likely to be accumulated in the inner space close to the one end 24a of the reflector 24 having the cylindrical structure. Therefore, the increase of the temperature of the LED 33 and the substrate 32 (LED module 21) facing the one end 24a of the reflector 24 can be effectively suppressed, and thus, the reduction of the optical output and the shortening of the life of the LED 33 can be prevented.

Furthermore, since the inner surface 22a of the heat transfer body 22 is coated with a heat absorbing material, the heat transfer body 22 absorbs the heat inside thereof, transfers the heat to the heat radiator fin unit 23 and radiates the heat. In addition, since the outer surface 22b of the heat transfer body 22 is also coated with a heat radiating material, the heat transfer body 22 quickly radiates the heat transferred from the LED module 21 and the heat absorbed from the inner space thereof into the outside space. Thus, the amount of heat radiated or transferred from the LED 33 to the reflector 24 is further reduced.

Therefore, the increase of the temperature of the one end 24a of the reflector 24 is further reduced, and the heat is even less likely to be accumulated in the inner space of the one end 24a of the reflector 24. As a result, the increase of the temperature of the LED 33 and the substrate 32 (LED module 21) disposed close to the one end of 24a of the reflector 24 is further reduced. As a result, the reduction of the optical output and the shortening of the life of the LEDs 33 can be preferably prevented.

As can be seen from the above description, even when the lamp device 14 is attached to a conventional lighting apparatus 11, the heat radiation fins 45 of the lamp device 14 are always disposed outside of the lighting apparatus 11, so that the heat radiation fins 45 can efficiently radiate heat. In particular, since the heat radiation fins 45 protrude beyond the apparatus attachment portion 38 of the heat transfer body 22 at which the lamp device 14 is tightly attached to the lighting apparatus housing 12, the heat radiation fins 45 of the lamp device 14 attached to the lighting apparatus 11 are surely disposed outside the lighting apparatus 11, so that the heat radiation fins 45 can efficiently radiate heat. As a result, the increase of the temperature of the LEDs 33 can be suppressed, and thus, the reduction of the optical output of the LEDs 33 and the shortening of the life of the LEDs 33 can be prevented.

In addition, since the outer surface of the peripheral wall portion 37 of the heat transfer body 22 provides a smooth circumferentially continuous curved surface, the lamp device 14 can be tightly mounted to the lighting apparatus 11 so as to provide a water-proof structure.

Furthermore, since the outer surface of the heat transfer body 22 is made smooth with no irregularity, the heat radiation from inside the lighting apparatus 11 to the outside and to the heat radiation fins 45 through the main body of the heat transfer body 22 can be made minimized, so that the heat radiation fins 45 can efficiently radiate the heat.

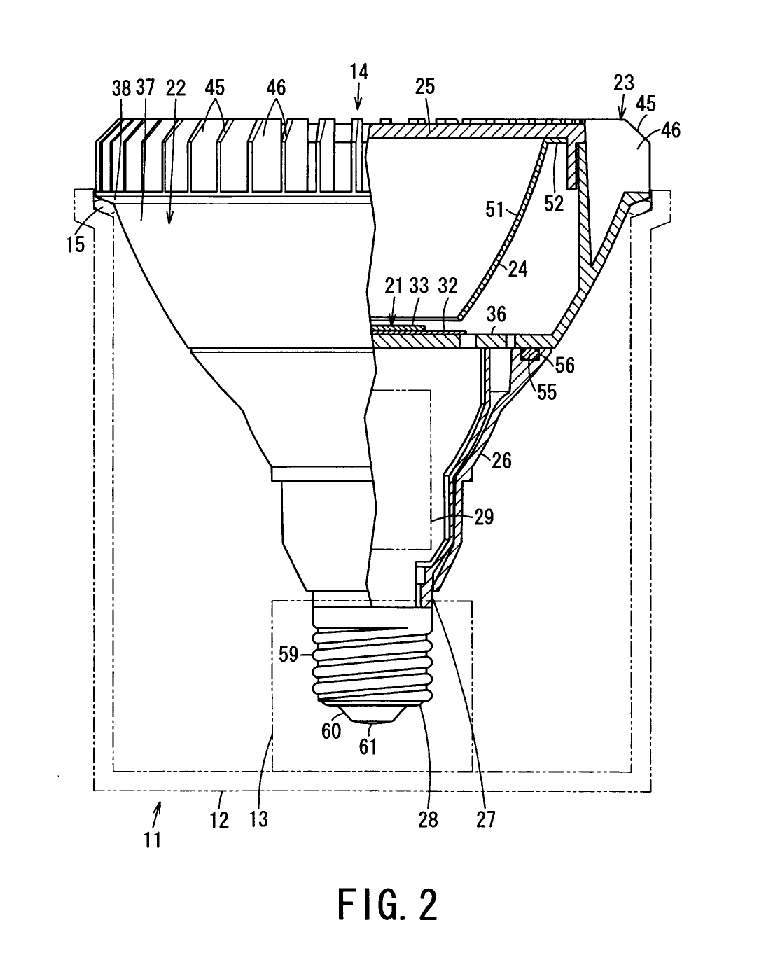

FIG. 2 shows a lighting apparatus incorporating a lamp device according to a second embodiment of the present invention.

In this embodiment, the heat transfer body 22 and the heat radiation fin unit 23 are integrally formed. More specifically, the plurality of radially extending heat radiation fins 45 are formed on the other end of the peripheral wall portion (expansion portion) 37 of the heat transfer body 22 at positions closer to the other end of the lamp device than the apparatus attachment part 38.

Since the heat transfer body 22 and the heat radiation fins 45 are integrally formed, the number of components can be reduced, and the heat is transferred from the heat transfer body 22 to the heat radiation fins 45 with improved efficiency. Consequently, the heat radiation can be improved.

The reflector 24 is attached to the light transmitting plate 25, and the light transmitting plate 25 is fitted in the end portion of the heat transfer body 22 closer to the other end of the lamp device 14 in a liquid-tight manner.

The application of the lamp device 14 is not limited to the water-proof lighting apparatus 11 described above, and the lamp device 14 may be applied to the other type of lighting apparatus.

The other portions of this second embodiment are substantially equal to those of the first embodiment shown in FIG. 1 and the descriptions thereof are omitted herein by adding the same reference numerals.

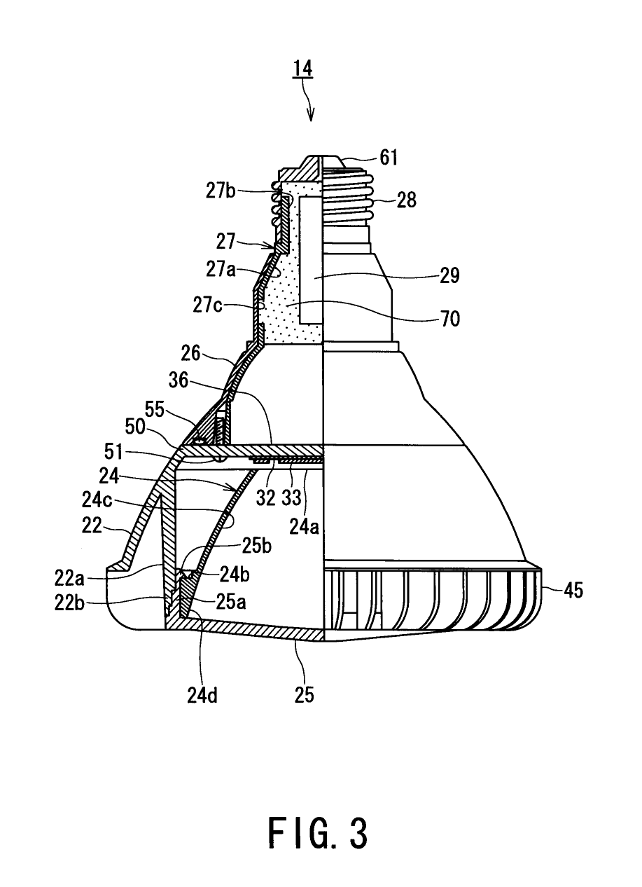

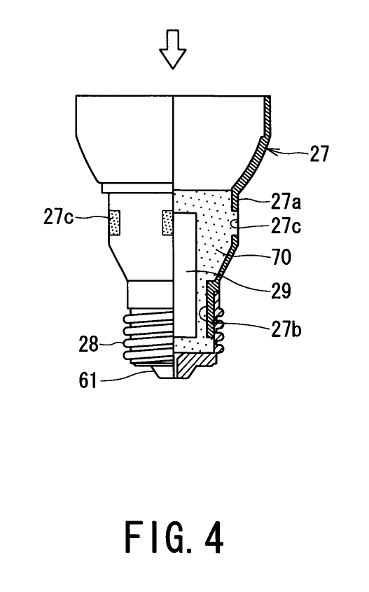

FIGS. 3 and 4 shows a lamp device representing a third embodiment of the present invention, in which FIG. 3 is a front view, similar to FIG. 1 or 2, partially cut away, and FIG. 4 is an inverted front view of the lamp device of FIG. 3 showing an upper half portion thereof with an insulation cover is partially eliminated. Further, in FIGS. 3 and 4, like reference numerals are added to portions or members corresponding to those of the first and second embodiments, and the duplicated explanations thereof are omitted herein.

The heat transfer body 22 of the lamp device 14 and the metallic outer case are coupled at a coupling portion 50 so as to provide a smooth surface condition. An O-ring 55 is concentrically arranged to the joining surface of the outer peripheral edge of the case 26 joined to the substrate mount portion 36 of the heat transfer body 22, and the heat transfer body 22 and the case are water-tightly coupled by fastening a plurality of screws 51 disposed concentrically annularly inside the O-ring 55.

As described in the former embodiments, the reflector 24 is made of aluminum or the like and is coated with a white acrylic backing paint or the like. The inner surface of the reflector 24 is formed as a reflecting surface 24c. The reflector 24 has the shape of a truncated cone expanding from the top open end 24a toward the bottom open end 24d, which serves as a light projecting opening. An outward engaging claw 25b is formed integrally with the circumference of the bottom open end 24d.

The heat transfer body 22 contains a straight cylindrical portion 22a that is formed integrally with the heat transfer body 22 so as to surround the reflector 24. An annular flange portion 25a of a front lens 25 as transparent material is fitted with a bottom open end portion 22b of the cylindrical portion 22a.

The front lens 25 may be of a light collection type or a light diffusion type depending on the application. The annular flange portion 25a of the front lens 25 is formed integrally with and approximately perpendicularly thereto along the circumferential direction of the inner surface thereof. The flange portion 25a has an inward engaging claw 25b formed at the inner end integrally with the flange portion 25a. The inward engaging claw 25b and the outward engaging claw 24b of the reflector 24 are engaged with each other.

Specifically, when the annular flange portion 25a of the front lens 25 is fitted, the inward engaging claw 25b of the flange portion 25a is pressed inwardly by the elastic restoring force of the bottom open end of the cylindrical portion 22a, and engaged with the outward engaging claw 24b of the reflector 24 and maintained in the engaged state.

Furthermore, the heat transfer body 22 has the annular heat radiator fins 45 made of a material having a high heat conductivity, such as aluminum, formed concentrically therewith and arranged on the circumferential direction of the light projecting open end 24d. The heat radiator fins 45 are of the structure similar to that of the first embodiment. However, the fin unit 23 of this third embodiment may be eliminated.

A cover includes an outer cover 26 and an inner cover 27, as mentioned in the former embodiment, and in this third embodiment, the inner cover is formed as an insulating case 27 made of an electrically insulating material arranged concentrically with the outer cover 26. The insulating material may be a ceramic or synthetic resin that has a relatively high heat radiating function and a high durability. The synthetic resin may be polybutylene terephthalate (PBT), for example.

The insulating case 27 comprises a main body 27a having approximately a truncated conical shape and a straight cylindrical portion 27b formed integrally with the top open end of the main body 27a. The outer surface of the main body 27a, which is concentric with the inner surface of the outer cover 26 of the metal outer case, is generally in intimate contact therewith and fixed thereto with a heat conductive silicone resin. The insulating case 27 is attached to the base 28 by fitting the resin cylindrical portion 27b into the open end of the base 28, for example.

The insulating case 27 further includes a housing section therein, in which the lighting circuit 29 is housed. The insulating case 27 is filled with a silicone resin 70, which is a heat conductive resin, and the silicone resin 70 is set. A top end portion, in FIG. 3, of the lighting circuit 29 extends into the base 28. The silicone resin 70 also fills the inside of the base 28 and is set therein. The base 28 is the E26 base and has an eyelet 61 serving as a power supply terminal on the side closer to the one end of the lamp device 14. The base 28 is fitted into a lamp socket 13 of the lighting apparatus when the lamp device 14 is attached to the lighting apparatus 11.

With reference to FIG. 4 illustrating the insulating case 27 in an inverted state, the truncated conical main body 27a of the insulating case 27 has a plurality of slits 27c each having a desired shape, such as a rectangular shape, serving as a through hole formed along the circumferential direction at a desired interval. The slit 27c is a through hole penetrating the insulating case 27 in the thickness direction. When the insulating case 27 is filled with the silicone resin, the silicone resin squeezes out through the slits 27c and adheres to the inner surface of the outer cover 26. This improves the strength of adhesion between the insulating case (as inner cover) 27 and the outer cover 26 and the strength of thermal coupling therebetween.

Furthermore, FIG. 4 represents a method of filling the insulating case 27 and the base 28 with the silicone resin 70. In this case, first, the lead of the lighting circuit 29 is connected to a desired point on the inner surface of the base 28. Then, the lighting circuit 29 is housed in the insulating case 27, and the base 28 is fitted into or otherwise attached to the cylindrical portion 27b of the insulating case 27 with the lighting circuit 29 housed therein.

Then, in the position shown in FIG. 4, where the base 28 is located below the insulating case 27, a required amount of silicone resin 70 is injected into the insulating case 27 from the direction indicated by a white arrow in the drawing. Then, the silicone resin 70 fills not only the insulating case 27 and but also the base 28 through the bottom open end of the cylindrical portion 27b of the insulating case 27 shown in FIG. 4 or the lead through hole formed to the base 28. Then, the silicone resin 70 is dried and set. In this way, the lighting circuit 29 housed in the insulating case 27 and the base 28 is fixed to the insulating case 27 and the base 28 with the silicone resin 70.

Next, an operation of the lamp device 14 configured as mentioned above will be described.

When the base 28 of the lamp device 14 is connected to a socket of a lighting apparatus, not shown, and power is supplied, the lighting circuit 29 starts to supply power to the LED 33, which then emits the light. Most of the light emitted by the LED 33 directly passes through the front lens 25 and is radiated frontward, and the remainder of the light is reflected by the reflecting surface 24c of the reflector 24 to pass through the front lens 25 and radiated frontward.

Heat generated by the light emission of the LED 33 is primarily transferred from substantially the entire back surface of the substrate mount portion 36 of the heat transfer body 22 through the adhesive and then is transferred to the outer cover 26 having the outer surface exposed to the outside through the coupling portion 50.

The heat transfer body 22 and the reflector 24 are expanded in the direction of lighting and therefore have a large outer surface serving to radiate heat, and are disposed to oppose to the lighting circuit 29, which serves as another heat source and requires thermal protection. Furthermore, the heat generated by the LED 33 as well as the lighting circuit 29 can be transferred to the base 28 and the insulating case 27 through the heat conductive silicone resin 70. The heat transferred to the insulating case 27 is then transferred to the metal outer case, which is in surface contact with the insulating case 27 and is exposed to the outside, and thus is radiated to the outside from the outer case.

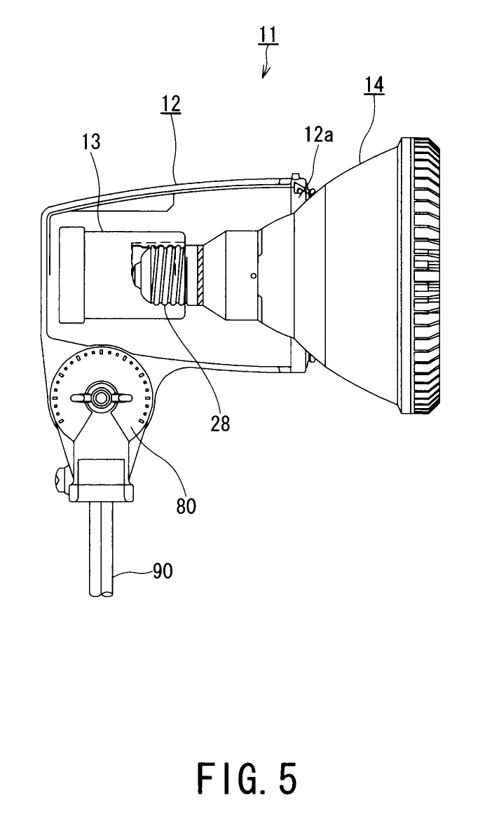

FIG. 5 illustrates a lighting apparatus, for example, as a light projector, provided with a lamp device according to the present invention, in which the lamp device 14 shown in FIG. 2 as the second embodiment shown is mounted as one example.

With reference to FIG. 5, the lighting apparatus 11 includes the lighting apparatus housing 12 having bottomed substantially conical structure having opened one end 12a. Inside the lighting apparatus housing 12 is disposed a socket 13 to which the base 28 of the lamp device 14 is screwed and secured thereto.

The lighting apparatus housing 12 is connected to a joint 80, into which a power source lead 90 is introduced, and the lead 90 is connected to the socket 13.

It is of course to be noted that the lamp device 14 of the first and third embodiments are also applicable to the lighting apparatus as mentioned above.

It is further to be noted that the present invention is not limited to the described embodiments, and many other changes and modifications may be made without departing from the scopes of the appended claims.

What is claimed is:

1. A lamp device, comprising:
a substrate;
a light emitting element mounted on the substrate;
a heat transfer body having a peripheral wall portion having one end expanding toward another one end, the substrate being attached to an inner surface of the one end of the heat transfer body;
a plurality of heat radiation fins disposed at the another one end of the peripheral wall portion of the heat transfer body;
a cover attached to the one end of the heat transfer body;
a base mounted to one end of the cover; and
a lighting circuit disposed inside the cover and adapted to trigger light emission of the light emitting element.

2. The lamp device according to claim 1, further comprising a cylindrical member disposed inside the heat transfer body, the cylindrical member having opened one end expanding toward another opened one end, wherein the opened one end is separated, in non-contact state, from the substrate and the heat transfer body and the another opened one end of the cylindrical member is fixed to the another one end of the heat transfer body.

3. The lamp device according to claim 2, wherein the cylindrical member is composed as a reflector having an inner surface formed as a reflecting surface for reflecting light from the light emitting element.

4. The lamp device according to claim 1, wherein the cover includes an outer cover and an inner cover, the inner cover comprising an insulating case having a housing in which the lighting circuit is housed, wherein the base is mounted to be communicated with the housing of the insulating case so as to close one end side of the insulating case, and a heat conductive resin fills the housing to the closed one end side of the insulating case with the lighting circuit being housed therein.

5. The lamp device according to claim 4, wherein the heat conductive resin is a silicone resin.

6. The lamp device according to claim 3, wherein the insulating case has a peripheral wall portion to which a through hole is formed so as to face an inner surface of the cover.

7. The lamp device according to claim 6, wherein the through hole includes a plurality of slits arranged at a predetermined interval and each having a rectangular shape.

8. The lamp device according to claim 1, wherein an apparatus attachment portion to be tightly attached to a lighting apparatus housing is formed on an outer surface of the peripheral wall portion of the heat transfer body, and the heat radiation fins protrude toward the another end of the lamp device beyond the apparatus attachment part.

9. A lighting apparatus comprising:
a lighting apparatus housing;
a socket disposed in the lighting apparatus housing; and
a lamp device comprising: a substrate; a light emitting element mounted on the substrate; a heat transfer body having a peripheral wall portion having one end expanding toward another one end, the substrate being attached to an inner surface of the one end of the heat transfer body; a plurality of heat radiation fins disposed at the another one end of the peripheral wall portion of the heat transfer body; a cover attached to the one end of the heat transfer body; a base mounted to one end of the cover; and a lighting circuit disposed inside the cover and adapted to trigger light emission of the light emitting element,
wherein the base of the lamp device is fitted into the socket, and the peripheral wall portion of the heat transfer body of the lamp device is tightly attached to the lighting apparatus housing at an outer surface thereof.
